(19) United States
(12) Patent Application Publication
(10) Pub. No.: US 2023/0258601 A1
(43) Pub. Date: Aug. 17, 2023

(54) ANALYZING SOUND WAVE PROPAGATION IN AN AQUATIC MEDIUM

(71) Applicant: International Business Machines Corporation, Armonk, NY (US)

(72) Inventors: MALGORZATA JADWIGA ZIMON, Warrington (GB); JAMES MCDONAGH, Frodsham (GB); BREANNDAN O'CONCHUIR, Warrington (GB)

(21) Appl. No.: 17/651,088

(22) Filed: Feb. 15, 2022

(51) Int. Cl. G01N 29/02; G01N 29/44

(52) U.S. Cl. CPC G01N 29/02; G01N 29/4472; G01N 2291/01; G01N 2291/022

(57) ABSTRACT

A tool for analysis of sound wave propagation in an aquatic medium. The tool generates a model representing the aquatic medium as a three-dimensional (3D) Gaussian random field, the 3D Gaussian random field being described by one or more correlation functions. The tool determines a propagation trajectory of a sound wave in the aquatic medium based on the 3D Gaussian random field.

### BACKGROUND OF THE INVENTION

Acoustic waves can propagate over a long distance in seawater. As a result, it is typical to use sound waves to communicate, as well as to navigate and track fixed or moving underwater targets.

As a significant component of ocean exploration, underwater acoustic target tracking and communication have attracted wide attention leading to development of numerous analytic theories, filtering algorithms and probabilistic modelling. In marine/aquatic environments, the speed of sound is affected by numerous variables, including temperature, pressure, salinity, etc.

### SUMMARY

Aspects of an embodiment of the present invention disclose a method, computer program product, and computer system for analyzing sound wave propagation in an aquatic medium. The method includes generating a model to represent the aquatic medium as a three-dimensional (3D) Gaussian random field, the 3D Gaussian random field being described by one or more correlation functions. The method further includes determining a propagation trajectory of a sound wave in the aquatic medium based, at least in part, on the 3D Gaussian random field.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 is a block diagram of an example system in which aspects of the illustrative embodiments may be implemented;

FIG. 2 is a flow diagram of a method for analyzing sound wave propagation in an aquatic medium according to an exemplary embodiment;

FIG. 3 is an illustration of a 3D Gaussian random field from the method of FIG. 2; and

FIG. 4 is a simplified block diagram of a computer system on which the method for populating a data entry field with data may be executed.

### DETAILED DESCRIPTION

Concepts are proposed for improved analysis of sound wave propagation in inhomogeneous media, where the speed of sound changes with depth and local conditions. In particular, the aquatic medium as a 3D Gaussian random field may be characterized by a set of correlation functions. By modelling the behavior of an acoustic wave in the medium, a sound propagation trajectory may be predicted. For instance, a receiver may obtain information (e.g., probability density functions, PDFs) representing the most likely frequencies, amplitudes for communication, and sound path for tracking. In a proposed embodiment, realism of the random field representation may be ensured using correlation function based on local measurements of the inhomogeneous media (e.g., aquatic environment). Proposed embodiments may, for example, be beneficial for many applications, including research and development for tsunami preparation, and detection, as well as underwater communication system for exploration activities. Also, in addition to underwater target tracking, the generation of PDFs of received frequencies may also lead to signal filtering by identification and classification of most likely information characteristics, opening yet further potential benefits (e.g., in encoding/decoding messages in the underwater communication).

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. If the term “adapted to” is used in the claims or description, it is noted the term “adapted to” is intended to be equivalent to the term “configured to”.

In the context of the present application, where embodiments of the present invention constitute a method, it should be understood that such a method may be a process for execution by a computer, i.e., may be a computer-implementable method. The various steps of the method may therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

Implementations in accordance with the present disclosure relate to various techniques, methods, schemes and/or solutions pertaining to the modelling and/or analysis of sound wave propagation in an aquatic medium. In particular, embodiments are directed to the improved analysis of sound wave propagation in inhomogeneous media, where the speed of sound changes with depth and local conditions. It is proposed to represent an aquatic medium as a 3D Gaussian random field described by one or more correlation functions.

For Autonomous Underwater Vehicles (AUVs) and the use of Underwater Sensor Networks (USNs), the uncertainty in underwater positioning and tracking, where the aquatic medium does not allow for efficient electromagnetic propagation, is problematic. Natural density fluctuations due to factors such as sediments and pollution in the ocean, however, degrade these abilities in ways that are difficult to forecast. For instance, frequency and amplitude attenuations of acoustic waves can be expected over long distances in the underwater environment. Such impairments force the use of Ultra Low Frequency (ULF) range, 0.3 to 3 kHz (kHz), for long range communication (because the attenuation is lower, relative to higher frequencies). As a result, only low rate data streams can be supported. Some recent proposals suggest incorporating real measurement data of sound speed in the ocean to improve tracking by, e.g., finding the related expression between the sound speed and the depth with the least square curve fitting method. However, such approaches may be limited (particularly for large distances) because measurements of the speed of sound will be sparse, leading to inaccurate estimations.

Embodiments may thus, for example, provide a system for improved underwater tracking and communication which utilizes Underwater Sensor Networks (USNs) and/or Autonomous Underwater Vehicles (AUVs) for probing the environment, data-driven random field modelling with Monte Carlo (MC)-based sampling for identifying the most likely sound wave trajectory and signal characteristics, and may potentially enable AUVs to follow a given underwater target.

The use of realistic correlation functions to characterize random fields for MC simulations may support real-time identification of the most likely acoustic paths, as well as frequency and amplitude content of the transferred information. By using data-driven forms of correlations, embodiments may ensure that the random fields represent the real physical environments in which the sound wave travels, thus enabling error bar estimation.

By treating an aquatic medium (e.g., marine environment) as random, embodiments may be based on an acceptance that there is inherent variability of local pressure values, and the medium may then be approximated as an ensemble of different possible scenarios at different depths. Stochastic three-dimensional (3D) processes may then be used as inputs for a high-throughput simulation of sound wave propagation enabling the estimation of potential outcomes (sound wave distortions).

Unlike conventional approaches for modelling inhomogeneous media (which employ a plurality of parallel layers, for example), it is proposed to represent an aquatic medium as a 3D Gaussian random field which is described by a data-driven correlation function.

Further embodiments of the proposed invention provide a computer-implemented method for analyzing sound wave propagation in an aquatic medium. The method comprises representing the aquatic medium as a three-dimensional (3D) Gaussian random field, the 3D Gaussian random field being described by one or more correlation functions. A propagation trajectory of a sound wave in the aquatic medium is then determined based on the 3D Gaussian random field.

The correlations may be modelled as functions with desirable properties, leading to efficient random field generation. Known methods are available that can handle correlation functions and marginal variance functions that are space dependent. Correlation parameters and functional form can, for example, be optimized based on information gathered by USNs and AUVs about the aquatic environment. The optimization can be performed with one of numerous known and well-established optimization algorithms.

In some embodiments, the determining the propagation trajectory of the sound wave may comprise providing the one or more correlation functions to generate realizations of a random field as an input to a Monte Carlo-based simulation to estimate an uncertainty of acoustic propagation in the aquatic medium. In this way, construction of realistic correlation functions may be leveraged for Monte Carlo-based simulations to identify, in real-time, the most likely acoustic paths, as well as frequency and amplitude content of the transferred information. Use of data-driven forms of correlations, for example, may ensure that the random fields represent the real physical environments in which the sound wave travels, enabling error bar estimation.

Some embodiments may further comprise generating a correlation function for describing a change in the 3D Gaussian random field based on data from at least one of: an autonomous underwater vehicle; and an underwater sensor network. For instance, generating the correlation function may comprise optimizing one or more parameters of the correlation function based on the data. For instance, correlation parameters and functional form may be optimized based on information gathered by USNs and AUVs about the aquatic environment. Such optimization may be performed using one or more known optimization algorithms.

That is, embodiments may propose concepts for improved underwater tracking and communication which utilise USNs and/or AUVs for probing the aquatic environment. By taking measurements of the water at different locations (potentially in real-time), embodiments may define correlation functions that can be used for performing stochastic modelling. A stochastic model of a wave propagation will then take realisations of a random field as an input describing the aquatic medium. The representation of the aquatic medium may be improved (e.g., more realistic) due to the data-driven correlation function that is used to characterize the 3D Gaussian random field. Proposed embodiments may thus employ a concept of probing an aquatic environment (comprising aquatic medium), adapting (potentially on the fly) the correlation information, which in turn makes the representation of the aquatic medium as a Gaussian random field more realistic. This more realistic representation may facilitate improved underwater tracking and communication. Furthermore, the computations may be performed using processing units USNs and/or AUVs, thus reducing a resource burden/cost.

Each spatial point in the 3D Gaussian random field may represent a variation in a property of the aquatic medium, such as local pressure for example.

Some embodiments may further comprise determining a first variation in frequency with propagation of the sound wave in the aquatic medium based on the 3D Gaussian random field.

By way of further example, an embodiment may also comprise determining a second variation in amplitude with propagation of the sound wave in the aquatic medium based on the 3D Gaussian random field. Embodiments may treat the aquatic medium as random, thus proposing that there is inherent variability of local pressure values and approximating the medium as an ensemble of different possible scenarios at different depths. Stochastic 3D processes may be used as inputs for a high-throughput simulation of sound wave propagation enabling the estimation of potential outcomes (sound wave distortions).

Embodiments may be employed in various applications. For example, there may be provided a method of underwater tracking or communication comprising analyzing sound wave propagation in an aquatic medium according to a proposed embodiment.

Furthermore, the proposed concept(s) may be advantageous for many other applications, including research and development for tsunami preparation and detection, as well as underwater communication system for exploration activities. Yet further, in addition to underwater tracking applications, the generation of PDFs of received frequencies may support signal filtering by identification and classification of most likely information characteristics, providing additional benefit.

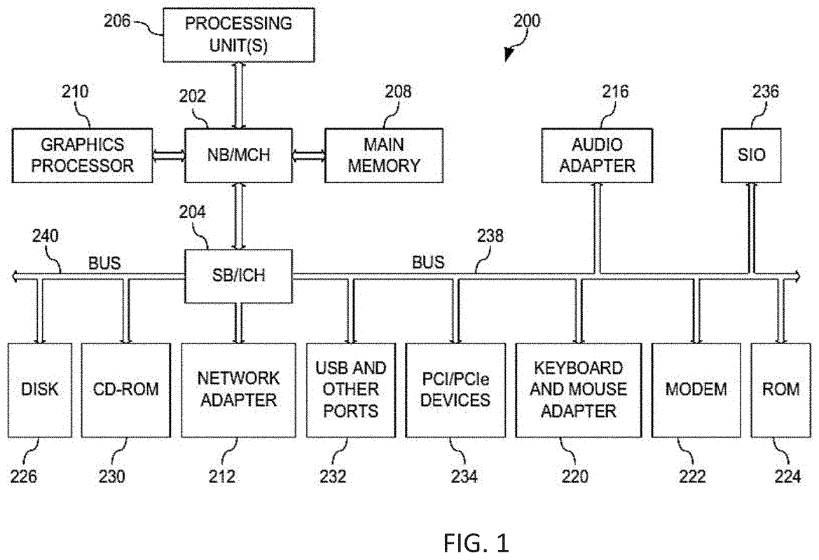

Turning now to FIG. 1, there is presented a block diagram of an example system 200 in which aspects of the illustrative embodiments may be implemented. The system 200 is an example of a computer, such as client in a distributed processing system, in which computer usable code or instructions implementing the processes for illustrative embodiments of the present invention may be located. For instance, the system 200 may be configured to implement a modelling unit and a processor arrangement unit according to an embodiment.

In the depicted example, the system 200 employs a hub architecture including a north bridge and memory controller hub (NB/MCH) 202 and a south bridge and input/output (I/O) controller hub (SB/ICH) 204. A processing unit 206, a main memory 208, and a graphics processor 210 are connected to NB/MCH 202. The graphics processor 210 may be connected to the NB/MCH 202 through an accelerated graphics port (AGP).

In the depicted example, a local area network (LAN) adapter 212 connects to SB/ICH 204. An audio adapter 216, a keyboard and a mouse adapter 220, a modem 222, a read only memory (ROM) 224, a hard disk drive (HDD) 226, a CD-ROM drive 230, a universal serial bus (USB) ports and other communication ports 232, and PCI/PCIe devices 234 connect to the SB/ICH 204 through first bus 238 and second bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

The HDD 226 and CD-ROM drive 230 connect to the SB/ICH 204 through second bus 240. The HDD 226 and CD-ROM drive 230 may use, for example, an integrated drive electronics (IDE) or a serial advanced technology attachment (SATA) interface. Super I/O (SIO) device 236 may be connected to SB/ICH 204.

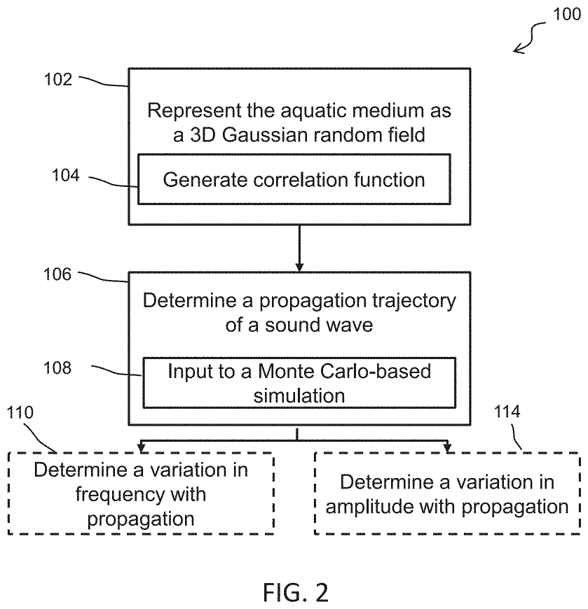

An operating system runs on the processing unit 206. The operating system coordinates and provides control of various components within the system 200 in FIG. 2. As a client, the operating system may be a commercially available operating system. An object-oriented programming system, such as the Java™ programming system, may run in conjunction with the operating system and provides calls to the operating system from Java™ programs or applications executing on system 200.

As a server, system 200 may be, for example, an IBM® eServer™ System p® computer system, running the Advanced Interactive Executive (AIX®) operating system or the LINUX® operating system. The system 200 may be a symmetric multiprocessor (SMP) system including a plurality of processors in processing unit 206. Alternatively, a single processor system may be employed.

Instructions for the operating system, the programming system, and applications or programs are located on storage devices, such as HDD 226, and may be loaded into main memory 208 for execution by processing unit 206. Similarly, one or more sound wave propagation analysis programs according to an embodiment may be adapted to be stored by the storage devices and/or the main memory 208.

The processes for illustrative embodiments of the present invention may be performed by processing unit 206 using computer usable program code, which may be located in a memory such as, for example, main memory 208, ROM 224, or in one or more peripheral devices 226 and 230.

A bus system, such as first bus 238 or second bus 240 as shown in FIG. 1, may comprise one or more buses. Of course, the bus system may be implemented using any type of communication fabric or architecture that provides for a transfer of data between different components or devices attached to the fabric or architecture. A communication unit, such as the modem 222 or the network adapter 212 of FIG. 1, may include one or more devices used to transmit and receive data. A memory may be, for example, main memory 208, ROM 224, or a cache such as found in NB/MCH 202 in FIG. 1.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the illustrative embodiments may be applied to a multiprocessor data processing system, other than the system mentioned previously, without departing from the spirit and scope of the present invention.

Moreover, the system 200 may take the form of any of a number of different data processing systems including client computing devices, server computing devices, a tablet computer, laptop computer, telephone or other communication device, a personal digital assistant (PDA), or the like. In some illustrative examples, the system 200 may be a portable computing device that is configured with flash memory to provide non-volatile memory for storing operating system files and/or user-generated data, for example. Thus, the system 200 may essentially be any known or later-developed data processing system without architectural limitation.

Referring now to FIG. 2, there is presented a flow diagram 100 of a computer-implemented method for analyzing sound wave propagation in an aquatic medium (such as a marine environment) according to an exemplary embodiment.

Step 102 comprises representing the aquatic medium as a three-dimensional (3D) Gaussian random field described by one or more correlation functions. In the 3D Gaussian random field, each spatial point represents a variation in a property of the aquatic medium, namely local pressure.

In this exemplary embodiment, step 102 includes the step 104 of generating a correlation function for describing a change in the 3D Gaussian random field based on data from at least one of: an autonomous underwater vehicle; and an underwater sensor network. That is, the embodiment utilizes USNs and AUVs for probing the environment and acquiring measurements of properties of the aquatic medium. By using measurements of the aquatic medium at different locations (potentially in real-time), correlation functions can be defined. Here, correlations are modelled as functions with desirable properties, leading to efficient random field generation. For this, many known methods are available that can handle correlation functions and marginal variance functions which are space dependent (e.g., as presented by Osborn et al., 2018). Furthermore, correlation parameters and functional form are optimized based on information gathered by USNs and AUVs about the aquatic environment. That is, the generating comprises optimizing one or more parameters of the correlation function based on the data (using any one of a wide range of known/conventional optimization algorithms, for example).

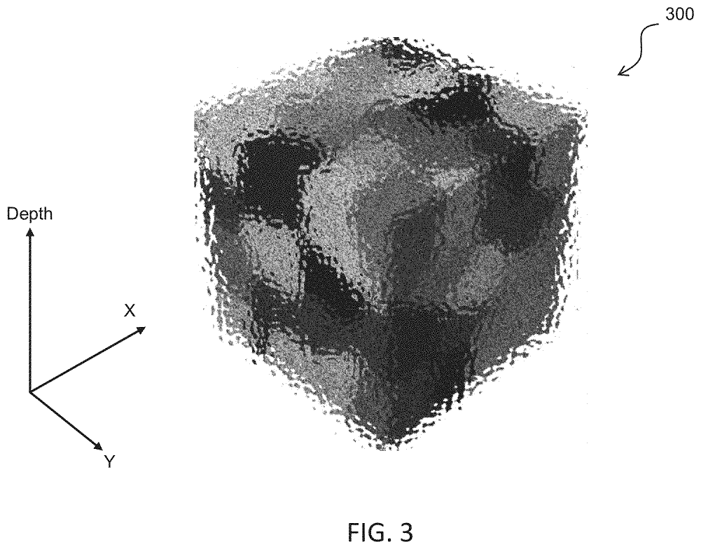

By way of example, an illustration of a 3D Gaussian random field 300 from step 102 is provided in FIG. 3. The illustration for FIG. 3 represents a signal, described as a vector, passing through regions with different properties in 3 dimensions. These regions are denoted by the differently shaded and/or colored patches. This visually depicts the need for a 3D random field accounting for the anisotropies of the local aquatic environment which are experienced by the signal and results in distortions. By treating the aquatic medium as random, it is acknowledged/accepted that there is inherent variability of local pressure values, and so the medium is approximated as an ensemble of different possible scenarios at different depths. These stochastic 3D processes are used as inputs for a high-throughput simulation of sound wave propagation enabling the estimation of potential outcomes (sound wave distortions).

Next, in step 106 a propagation trajectory of a sound wave in the aquatic medium is determined based on the 3D Gaussian random field. Specifically, step 106 of determining the propagation trajectory of the sound wave comprises the step 108 of providing the one or more correlation functions to generate realizations of a random field as an input to a Monte Carlo-based simulation to estimate an uncertainty of acoustic propagation in the aquatic medium.

By modelling the behavior of an acoustic waves in each sample of the medium, we can, e.g., identify the most likely sound propagation trajectory. The receiver obtains information in the form of PDFs representing the most likely frequencies, amplitudes for communication, and sound path for tracking. For instance, the PDFs of sound waves can be obtained by either performing multi-level MC, or one of the sparse variants of surrogate-based techniques (presented by Sullivan in ‘Introduction to uncertainty quantification. Springer’, 2015).

Accordingly, the flow diagram 100 of FIG. 2 may also include the additional steps 110 and 114 of determining variations in frequency and amplitude with propagation of the sound wave in the aquatic medium, respectively.

In an alternative embodiment, a matrix of autonomous underwater vehicles (AUV) and underwater sensor networks (USN) is utilized for underwater data collection. In the alternative embodiment, the data collection includes, but is not limited to, collection of sensory data and measurements of salinity in a body of water. In the alternative embodiment, the USNs include one or more processing units for retrieving data from a database, where the data includes, but is not limited to, historical data and one or more models of correlation functions related to an aqueous medium, and where the data is further utilized by the USNs to determine a parametric form of the correlation functions. In the alternative embodiment, the USNs process the data retrieved from the database to determine an optimal correlation and perform random field generation for describing the aqueous medium. In the alternative embodiment, the USNs transmit the determined optimal correlation and the random field generation output to a receiver unit. In the alternative embodiment, the receiver unit receives data being transferred from a signal source via acoustic waves in the aqueous medium, and further transmits stochastic inputs and probabilities to one or more additional processing units. In the alternative embodiment, the one or more additional processing units perform Monte Carlo (MC) processing of a wave propagation model, and further transmit decoded signal information along with an error estimation to a computer device utilized by a boat and/or diver operating in the aqueous medium.

From the above-described method, it will be appreciated that there is proposed a concept for improved underwater tracking and communication, which may utilize USNs and AUVs for probing the aquatic environment. Such a concept may leverage data-driven random field modelling with MC-based sampling for identifying the most likely sound wave trajectory and signal characteristics, thus potentially enabling AUVs to follow a given underwater target.

In particular, it is proposed to employ the construction of realistic correlation functions for MC simulations in order to identify the most likely acoustic paths, as well as frequency and amplitude content of the transferred information. By using data-driven forms of correlations, embodiment may ensure that the random fields represent the real physical environments in which the sound wave travels, enabling error bar estimation.

Improved analysis of sound wave propagation in inhomogeneous media, where the speed of sound changes with depth and local conditions, may therefore be facilitated by proposed embodiments.

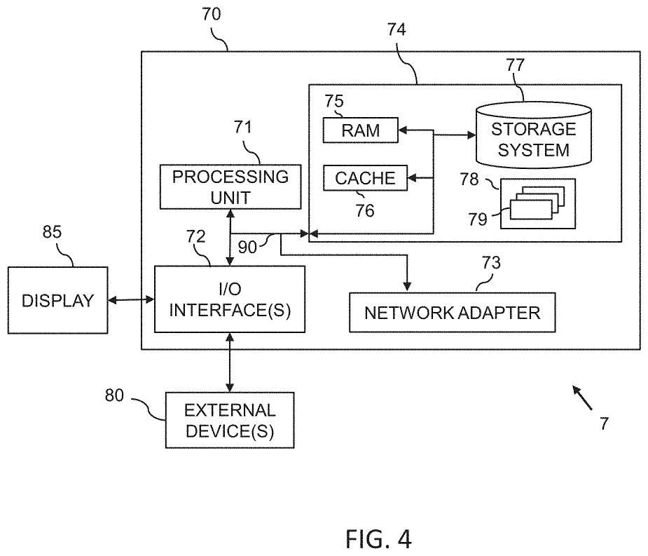

By way of further example, as illustrated in FIG. 4, embodiments may comprise a computer system 70, which may form part of a networked system 7. For instance, a system for analyzing sound wave propagation in an aquatic medium may be implemented by the computer system 70. The components of computer system/server 70 may include, but are not limited to, one or more processing arrangements, for example comprising processors or processing units 71, a system memory 74, and a bus 90 that couples various system components including system memory 74 to processing unit 71.

System memory 74 can include computer system readable media in the form of volatile memory, such as random access memory (RAM) 75 and/or cache memory 76. Computer system/server 70 may further include other removable/non-removable, volatile/non-volatile computer system storage media 77. In such instances, each can be connected to bus 90 by one or more data media interfaces. The memory 74 may include at least one program product having a set (e.g., at least one) of program modules that are configured to carry out the functions of proposed embodiments. For instance, the memory 74 may include a computer program product having program executable by the processing unit 71 to cause the system to perform, a method for analyzing sound wave propagation in an aquatic medium according to a proposed embodiment.

Program/utility 78, having a set (at least one) of program modules 79, may be stored in memory 74. Program modules 79 generally carry out the functions and/or methodologies of proposed embodiments for analyzing sound wave propagation in an aquatic medium.

Computer system/server 70 may also communicate with one or more external devices 80 such as a keyboard, a pointing device, a display 85, etc.; one or more devices that enable a user to interact with computer system/server 70; and/or any devices (e.g., network card, modem, etc.) that enable computer system/server 70 to communicate with one or more other computing devices. Such communication can occur via Input/Output (I/O) interfaces 72. Still yet, computer system/server 70 can communicate with one or more networks such as a local area network (LAN), a general wide area network (WAN), and/or a public network (e.g., the Internet) via network adapter 73 (e.g., to communicate recreated content to a system or user).

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The mere fact that certain measures are recited in mutually different dependent claims does not indicate that a combination of these measures cannot be used to advantage.

Any reference signs in the claims should not be construed as limiting the scope.

What is claimed is:

1. A computer-implemented method for analyzing sound wave propagation in an aquatic medium, the method comprising:
generating a model to represent the aquatic medium as a three-dimensional (3D) Gaussian random field, the 3D Gaussian random field being described by one or more correlation functions; and
determining a propagation trajectory of a sound wave in the aquatic medium based, at least in part, on the 3D Gaussian random field.

2. The computer-implemented method of claim 1, wherein determining the propagation trajectory of the sound wave comprises:
providing the one or more correlation functions to generate realizations of a random field as an input to a Monte Carlo-based simulation to estimate an uncertainty of acoustic propagation in the aquatic medium.

3. The computer-implemented method of claim 1, further comprising:
generating a correlation function for describing a change in the 3D Gaussian random field based on data from one or more underwater sensors.

4. The computer-implemented method of claim 3, wherein generating the correlation function comprises optimizing one or more parameters of the correlation function based on the data.

5. The computer-implemented method of claim 1, wherein each spatial point in the 3D Gaussian random field represents a variation in at least one property of the aquatic medium, wherein the at least one property of the aquatic medium includes a local pressure.

6. The computer-implemented method of claim 1, further comprising:
determining a first variation in frequency with propagation of the sound wave in the aquatic medium based on the 3D Gaussian random field.

7. The computer-implemented method of claim 1, further comprising:
determining a second variation in amplitude with propagation of the sound wave in the aquatic medium based on the 3D Gaussian random field.

8. A computer program product for analyzing sound wave propagation in an aquatic medium, the computer program product comprising:
one or more computer readable storage media and program instructions stored on the one or more computer readable storage media, the stored program instructions comprising:
program instructions to generate a model representing the aquatic medium as a three-dimensional (3D) Gaussian random field, the 3D Gaussian random field being described by one or more correlation functions; and
program instructions to determine a propagation trajectory of a sound wave in the aquatic medium based on the 3D Gaussian random field.

9. The computer program product of claim 8, wherein the program instructions to determine the propagation trajectory of the sound wave further comprise:
program instructions to provide the one or more correlation functions to generate realizations of a random field as an input to a Monte Carlo-based simulation to estimate an uncertainty of acoustic propagation in the aquatic medium.

10. The computer program product of claim 8, the stored program instructions further comprising:
program instructions to generate a correlation function for describing a change in the 3D Gaussian random field based on data from one or more underwater sensors.

11. The computer program product of claim 10, wherein the program instructions to generate the correlation function further comprise:
program instructions to optimize one or more parameters of the correlation function based on the data.

12. The computer program product of claim 8, wherein each spatial point in the 3D Gaussian random field represents a variation in at least one property of the aquatic medium, wherein the at least one property of the aquatic medium includes a local pressure.

13. The computer program product of claim 8, the stored program instructions further comprising:
program instructions to determine a first variation in frequency with propagation of the sound wave in the aquatic medium based on the 3D Gaussian random field.

14. The computer program product of claim 8, the stored program instructions further comprising:
program instructions to determine a second variation in amplitude with propagation of the sound wave in the aquatic medium based on the 3D Gaussian random field.

15. A computer system for analyzing sound wave propagation in an aquatic medium, the computer system comprising:
one or more computer processors;
one or more computer readable storage media; and
program instructions stored on at least one of the one or more computer readable storage media for execution by at least one of the one or more computer processors, the stored program instructions comprising:
program instructions to generate a model representing the aquatic medium as a three-dimensional (3D) Gaussian random field, the 3D Gaussian random field being described by one or more correlation functions; and
program instructions to determine a propagation trajectory of a sound wave in the aquatic medium based on the 3D Gaussian random field.

16. The computer system of claim 15, wherein the program instructions to determine the propagation trajectory of the sound wave further comprise:
program instructions to provide the one or more correlation functions to generate realizations of a random field as an input to a Monte Carlo-based simulation to estimate an uncertainty of acoustic propagation in the aquatic medium.

17. The computer system of claim 15, the stored program instructions further comprising:
program instructions to generate a correlation function for describing a change in the 3D Gaussian random field based on data from one or more underwater sensors.

18. The computer system of claim 17, wherein the program instructions to generate the correlation function further comprise:
program instructions to optimize one or more parameters of the correlation function based on the data.

19. The computer system of claim 15, wherein each spatial point in the 3D Gaussian random field represents a variation in at least one property of the aquatic medium, wherein the at least one property of the aquatic medium includes local pressure.

20. The computer system of claim 15, the stored program instructions further comprising:
program instructions to determine a first variation in frequency with propagation of the sound wave in the aquatic medium based on the 3D Gaussian random field.
